(19) United States
(12) Patent Application Publication
(10) Pub. No.: US 2017/0192245 A1
(43) Pub. Date: Jul. 6, 2017

(54) Panel Assembly with a Three-Dimensional Visual Effect

(71) Applicant: Sheng-Wen Lai, Taichung City (TW)

(72) Inventor: Sheng-Wen Lai, Taichung City (TW)

(21) Appl. No.: 15/228,486

(22) Filed: Aug. 4, 2016

(30) Foreign Application Priority Data
Dec. 31, 2015 (TW) 104144605

(51) Int. Cl. G02B 27/22; G02B 27/02

(52) U.S. Cl. CPC G02B 27/2221; G02B 27/028

(57) ABSTRACT

A panel assembly with a three-dimensional visual effect includes a panel unit, an image layer unit, and a frame surrounding the panel unit. The panel unit includes a substrate and at least one transparent acrylic panel. The substrate has a top surface that includes an upper region and at least one lower region. The transparent acrylic panel is disposed on the lower region, and includes a transparent top surface. The image layer unit includes a primary image layer which is interposed between the lower region and the transparent acrylic panel, and a secondary image layer which is superimposed on the upper region, treated with a crystallization process, and flush with the transparent top surface.

### CROSS REFERENCE TO RELATED APPLICATION

This application claims priority of Taiwanese Patent Application Number 104144605, filed on Dec. 31, 2015.

### FIELD

The disclosure relates to a panel assembly, more particularly to a panel assembly with a three-dimensional visual effect.

### BACKGROUND

With market trends favoring increased aesthetic standards for everyday household items, ranging from personal accessories to home furnishings, the ability to customize products and meet individual consumer preferences has become more important than ever.

Panels are one such item, in which customizing the texture and applying special treatments to the surfaces of the panels can improve the aesthetics of the product and provide consumers with a high degree of versatility. For example, a conventional album cover, an example of the panel, is typically manufactured by first printing a pattern on a sheet of a plate material, then coating a transparent film on the plate material as a protective layer. However, the album cover manufactured in this manner is quite simple in terms of design.

In order to meet the demands of the market, the panels are now able to be individually customized in terms of design, a plate material, and a material of the protective layer. The surface textures of the panels can also be altered by application of a surface treatment.

For example, the crystallization process is a treatment process that can increase the durability, heat-resistance, and wear-resistance of the panels. Furthermore, the crystallization process can enhance the color saturation and transparency of the panel surface, and generate a mirror effect to provide a sense of depth associated with the panels. Typically, the crystallization process can be the application of piano lacquer on photographic paper, or adherence of a crystal film on photographic paper. Piano lacquer is quite expensive due to the need for relatively complex procedures such as varnishing and grinding. On the other hand, crystal film application on the photographic paper is a relatively less complex and low-cost process that can achieve a degree of transparency similar to that of piano lacquer application, and is thus often presented as an alternative option to piano lacquer application.

Moreover, at present, the crystallization process is only employed on a surface of a single panel. Also, there is currently no substance that can provide a three-dimensional visual effect and retain the three-dimensional visual effect at different viewing angles or distances.

### SUMMARY

Therefore, an object of the present disclosure is to provide a panel assembly with a three-dimensional visual effect that can alleviate at least one of the drawbacks associated with the prior art.

According to the present disclosure, a panel assembly with a three-dimensional visual effect includes a panel unit, an image layer unit, and a frame.

The panel unit includes a substrate and at least one transparent acrylic panel. The substrate has a top surface and a bottom surface opposite to the top surface. The top surface includes an upper region and at least one lower region that is nearer to the bottom surface than is the upper region. The at least one transparent acrylic panel is disposed on the lower region, and includes a transparent top surface and a connecting surface that is opposite to the transparent top surface and in contact with the lower region of the substrate.

The image layer unit includes a primary image layer and a secondary image layer. The primary image layer is disposed on the lower region of the substrate and superimposed by the transparent acrylic panel so as to be interposed between the lower region of the substrate and the connecting surface of the transparent acrylic panel. The secondary image layer is superimposed on the upper region of the substrate and spaced apart from the primary image layer, and treated with a crystallization process.

The frame surrounds the panel unit to secure the substrate and the transparent acrylic panel.

The transparent top surface is flush with the secondary image layer of the image layer unit.

### BRIEF DESCRIPTION OF THE DRAWINGS

Other features and advantages of the disclosure will become apparent in the following detailed description of the embodiments with reference to the accompanying drawings, of which:

FIG. 1 is a perspective and partly sectional view of an embodiment of a panel assembly with a three-dimensional visual effect according to the present disclosure;

FIG. 2 is a fragmentary sectional view of the embodiment illustrating lines of sight A, B, of a user directed toward secondary and primary image layers of an image layer unit, respectively; and

FIG. 3 is a perspective and partly sectional view of a variation of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

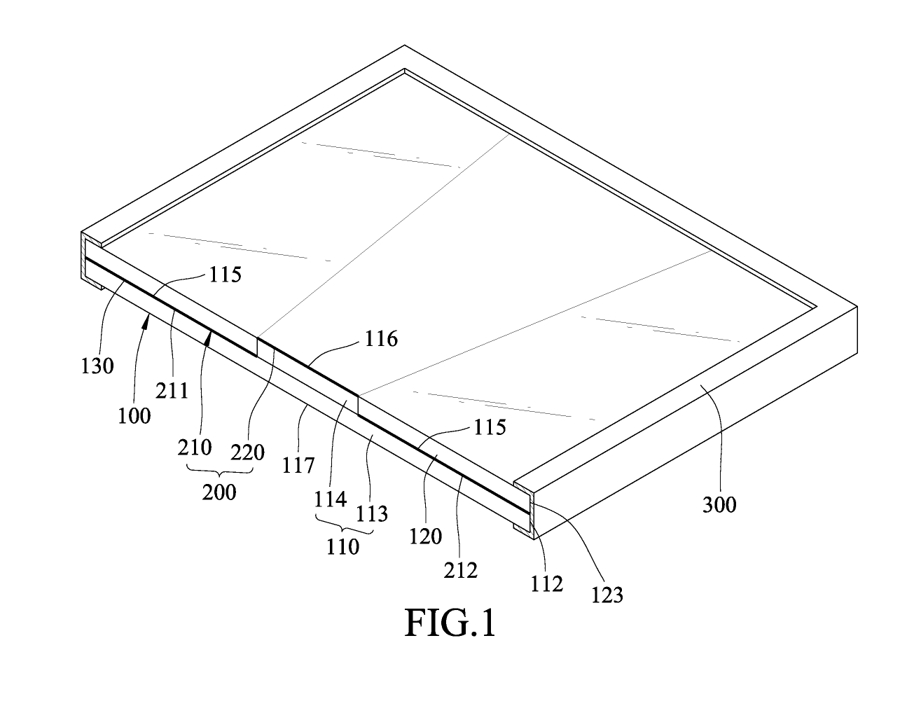

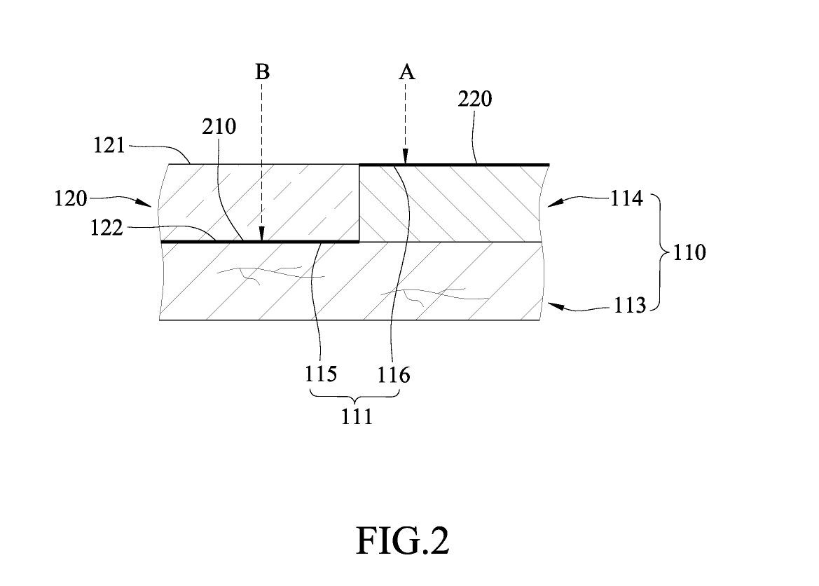

Referring to FIGS. 1 and 2, an embodiment of a panel assembly with a three-dimensional visual effect according to the present disclosure is shown to include a panel unit 100, an image layer unit 200, and a frame 300.

The panel unit 100 includes a substrate 110 and at least a transparent acrylic panel 120. In this embodiment, the panel unit 100 includes two of the transparent acrylic panels 120.

The substrate 110 has a top surface 111, a bottom surface 117 opposite to the top surface 111, and a peripheral surface 112 interconnecting the top surface 111 and the bottom surface 117. The top surface 111 includes an upper region 116 and at least one lower region 115 that is nearer to the bottom surface 117 than is the upper region 116. As shown in FIG. 1, there are two of the lower regions 115 in this embodiment.

In this embodiment, the substrate 110 includes a lower plate 113 and an upper plate 114 stacked on the lower plate 113. Specifically, the upper region 116 of the substrate 110 is formed on a top surface of the upper plate 114, and the lower regions 115 of the substrate 110 are formed on a top surface of the lower plate 113 and are separated from each other by the upper plate 114.

It should be noted that the substrate may be made of a material, e.g., wood, metal, composite, etc., although typically the substrate is made of the wood material. For example, the lower plate 113 may be made of timber. Furthermore, the upper plate 114 may have different shapes and be made of different materials for purposes of versatility.

The transparent acrylic panels 120 are respectively disposed on the lower regions of the substrate 110 and each includes a transparent top surface 121, a connecting surface 122 that is opposite to the transparent top surface 121 and in contact with a respective one of the lower regions 115, and a peripheral surface 123 interconnecting the transparent top surface 121 and the connecting surface 122. Furthermore, the peripheral surface 123 of the transparent acrylic panel 120 and the peripheral surface 112 of the substrate cooperate to form a seam 130.

The image layer unit 200 includes a primary image layer 210 and a secondary image layer 220. The primary image layer 210 is disposed on the lower regions 115 of the substrate 110 and superimposed by the transparent acrylic panels 120 so as to be interposed between the lower regions 115 of the substrate 110 and the connecting surfaces 122 of the transparent acrylic panels 120. In this embodiment, the primary image layer 210 has first and second portions 211, 212, that are respectively interposed between a respective one of the lower regions 115 and the connecting surface 122 of a respective one of the transparent acrylic panels 120. The secondary image layer 220 is superimposed on the upper region 116 of the substrate 110 and spaced apart from the primary image layer 210.

In this embodiment, the secondary image layer 220 is treated with a crystallization process, such as piano lacquer application or crystal film application. Specifically, after superimposing the secondary image layer 220 on the upper region 116 of the substrate 110, piano lacquer application may be achieved by repeatedly applying piano lacquer on the secondary image layer 220 and polishing the piano lacquer. In this way, the secondary image layer 220 coated with the piano lacquer may have high translucency. Alternatively, after the step of superimposing the secondary image layer 220 on the upper region 116 of the substrate 110, crystal film application may be achieved by directly adhering a crystal film on the secondary image layer 220. In this way, the secondary image layer 220 applied with the crystal film may have a texture similar to that of the secondary image layer 220 coated with the piano lacquer.

In this embodiment, at least one of the primary image layer 210 or the secondary image layer 220 may be paper, such as color photographic paper, color printing paper, or color inkjet paper.

Furthermore, in this embodiment, the primary and secondary image layers 210, 220 may share a related theme, such as a related color scheme. As another example, if the panel assembly of the present disclosure were to be used as an album cover for an album of wedding dress photos, the primary image layer 210 may be a photo of a bride wearing a wedding dress, while the second image layer 220 may feature wedding blessing quotes or advertisements by the wedding photography company. Thus, there may be a complementary relationship between the primary and secondary image layers 210, 220.

The frame 300 surrounds and is connected to the peripheral surface 112 of the substrate 110 and the peripheral surface 123 of the transparent acrylic panel 120 of the panel unit 100 so as to secure the substrate 110 and the transparent acrylic panel 120, and enclose the seam 130. It is worth mentioning that Taiwanese Patent Publication Number M477387, which is a patent held by the same inventor of the present disclosure, discloses a frame structure which includes a plurality of strips interconnected among one another in a side-by-side manner for enclosing seams of plates made of different materials. Hence, the frame 300 of the present disclosure may adopt the frame structure of Taiwanese Patent Publication Number M477387, and the related structure and components are not further discussed hereinafter.

As illustrated in FIG. 2, lines of sight (A, B) of a user are directed toward the secondary and primary image layers 220, 210 of the image layer unit 200, respectively.

Since the upper and lower regions 116, 115 of the substrate 110 are not aligned with one another, and hence the secondary and primary image layers 220, 210 are not aligned with one another, the user may observe a distance along line of sight (A), which directly falls upon the secondary image layer 220, to be different from that along line of sight (B), which indirectly falls upon the primary image layer 210 through the transparent acrylic panels 120. Specifically, the user may observe the distance along line of sight (A) and associated with the secondary image layer 220 disposed on the upper region 116, to be less than the distance along line of sight (B) and associated with the primary image layer 210 disposed on the lower regions 115.

The crystallization process applied to the secondary image layer 220 results in a mirror effect associated with the secondary image layer 220 which causes the user to perceive the distance along line of sight (A) to be shorter than its actual distance. In other words, the secondary image layer 220 treated with the crystallization process presents a convex visual effect for the user viewing the secondary image layer 220.

On the other hand, the transparent acrylic panel 120 superimposed on the primary image layer 210 requires that the line of sight (B) penetrate the transparent acrylic panel 120, resulting in the user perceiving the distance along line of sight (B) to be greater than its actual distance. In other words, the primary image layer 210 being superimposed by the transparent acrylic panel 120 presents a concave visual effect for the user viewing the primary image layer 210.

Therefore, the primary image layer 210 being superimposed by the transparent acrylic panel 120 and the secondary image layer 220 being treated with the crystallization process cooperatively and respectively present concave and convex visual effects to provide a three-dimensional visual effect for the user.

In this embodiment, the transparent acrylic panel 120 has a thickness ranging between 1.5 mm and 20 mm. The different thicknesses of the transparent acrylic panel 120 may alter the three-dimensional visual effect to the user. If the transparent acrylic panel 120 does not have sufficient thickness, i.e., a thickness less than 1.5 mm, the expected three-dimensional visual effect will not be generated for the user viewing the primary image layer 210. In actual practice, an optimal three-dimensional visual effect is achieved when the transparent acrylic panel 120 has a thickness ranging between 1.5 mm and 5 mm, and a bright and eye-catching effect of the secondary image layer 220 may be achieved when the transparent acrylic panel 120 has a thickness ranging between 5 mm and 20 mm.

It should be noted that the transparent acrylic panels 120 may be contoured to complement the shape of the upper plate 114 of the substrate 110. Accordingly, when the transparent acrylic panels 120 are respectively disposed on the lower regions 115 of the substrate 110, the transparent top surface 121 of each of the transparent acrylic panels 120 is flush with the secondary image layer 220 of the image layer unit 200 so that the transparent top surfaces 121 of the transparent acrylic panels 120 and the secondary image layer 220 of the image layer unit 200 form a substantially planar surface and appear to be integrally formed.

It should be further noted that the number of the transparent acrylic panel 120 of this embodiment is not limited to one, but may also be greater than one.

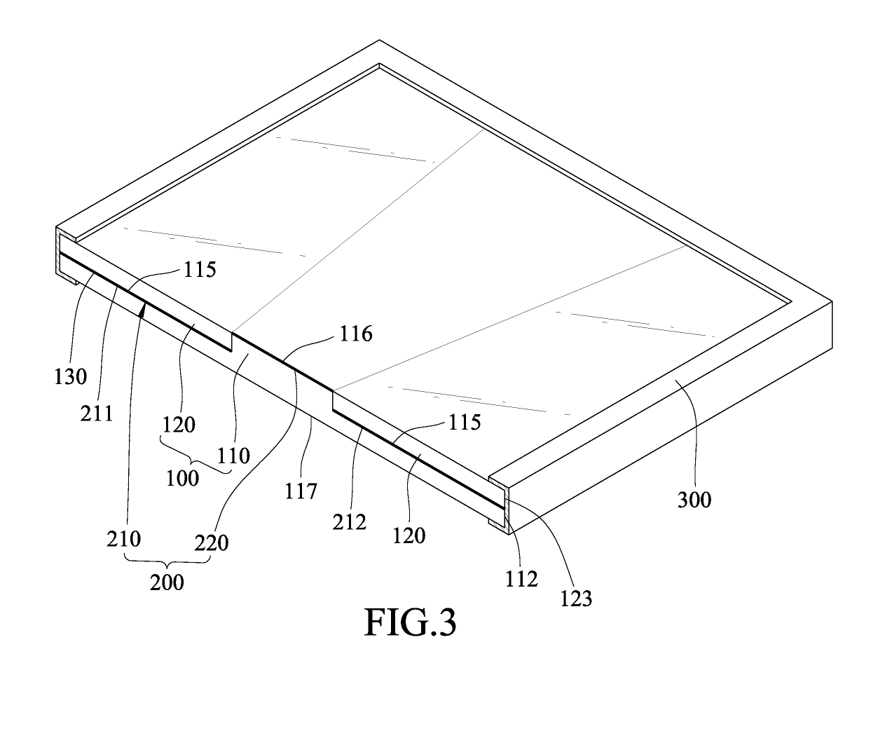

FIG. 3 illustrates a variation of the embodiment. Specifically, the substrate 110 may be made by processing a plate using machines, e.g., laser engraving machines, computer numerical processing machines (CNC), etc., to form the lower region 115 and the upper region 116, so that the lower plate 113 and the upper plate 114 stacked on the lower plate 113 are not necessary to achieve a three-dimensional configuration.

Overall, the panel assembly may be used in products such as album covers, jewelry boxes, cabinets, wooden car interiors, key racks, wooden panels of audio equipment, etc., and can be customized depending on client preferences.

In summary, with the upper and lower regions 116, 115 of the substrate 110 being not flush with one another and with the arrangement of the transparent acrylic panel 120 and the application of the crystallization treatment, the primary image layer 210 which is superimposed by the transparent acrylic panel 120 and the secondary image layer 220 which is treated with the crystallization process cooperatively and respectively present concave and convex visual effects to provide a three-dimensional visual effect for the user. In this way, the panel assembly of the present disclosure provides a three-dimensional visual effect.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A panel assembly with a three-dimensional visual effect comprising:
a panel unit including
a substrate having a top surface and a bottom surface opposite to said top surface, said top surface including an upper region and at least one lower region, said lower region being nearer to said bottom surface than is said upper region,
at least one transparent acrylic panel being disposed on said lower region and including a transparent top surface and a connecting surface opposite to said transparent top surface and in contact with said lower region of said substrate;
an image layer unit including
a primary image layer disposed on said lower region of said substrate and superimposed by said transparent acrylic panel so as to be interposed between said lower region of said substrate and said connecting surface of said transparent acrylic panel, and
a secondary image layer superimposed on said upper region of said substrate and spaced apart from said primary image layer, and treated with a crystallization process; and
a frame surrounding said panel unit to secure said substrate and said transparent acrylic panel;
wherein said transparent top surface is flush with said secondary image layer of said image layer unit.

2. The panel assembly as claimed in claim 1, wherein said substrate has a peripheral surface that interconnects said top surface and said bottom surface, said transparent acrylic panel having a peripheral surface that interconnects said transparent top surface and said connecting surface, said frame surrounding and connected to said peripheral surface of said substrate and said peripheral surface of said transparent acrylic panel.

3. The panel assembly as claimed in claim 1, wherein said substrate includes a lower plate and an upper plate stacked on said lower plate, said upper region of said substrate being formed on a top surface of said upper plate, said lower region of said substrate being formed on a top surface of said lower plate.

4. The panel assembly as claimed in claim 1, wherein said crystallization process is one of piano lacquer application and crystal film application.

5. The panel assembly as claimed in claim 1, wherein at least one of said primary image layer or said secondary image layer is paper.

6. The panel assembly as claimed in claim 5, wherein said paper is selected from the group consisting of color photographic paper, color printing paper, and color inkjet paper.

7. The panel assembly as claimed in claim 1, wherein said transparent acrylic panel has a thickness ranging between 1.5 mm and 20 mm.
